(19) United States
(12) Patent Application Publication
(10) Pub. No.: US 2025/0216754 A1
(43) Pub. Date: Jul. 3, 2025

(54) FOLDABLE CAMERA AID

(71) Applicant: Shenzhen DeOne Innovation Technology Co.,LTD., Shenzhen (CN)

(72) Inventor: Jianle Li, Quanzhou (CN)

(73) Assignee: Shenzhen DeOne Innovation Technology Co.,LTD., Shenzhen (CN)

(21) Appl. No.: 18/919,085

(22) Filed: Oct. 17, 2024

(30) Foreign Application Priority Data
Dec. 28, 2023 (CN) 2023236118015

(51) Int. Cl. G03B 17/56; H04M 1/72409

(52) U.S. Cl. CPC G03B 17/563; H04M 1/72409

(57) ABSTRACT

A foldable camera aid is disclosed, including a camera aid body. The camera aid body includes a grip and a bracket, one side of the bracket away from the grip is provided with a fitting part for assembly of a mobile device. The camera aid body is provided with a control circuit board coupled with a signal transmission unit, and the signal transmission unit is signal connected to the mobile device. The camera aid body is further provided with a storage module coupled to the control circuit board, and the storage module is configured to, via the signal transmission unit, store data information of the mobile device or send the data information to the mobile device. The foldable camera aid can store and read the data information of the mobile device, and also can reduce the temperature of the mobile device when shooting.

### CROSS REFERENCE TO RELATED APPLICATION

This application claims priority to Chinese Patent Application No. 2023236118015, filed on Dec. 28, 2023, which is hereby incorporated by reference in its entirety.

### TECHNICAL FIELD

The present application relates to the technical field of camera aids, and in particular to a foldable camera aid.

### BACKGROUND

Nowadays, with increasing use of cell phones and due to their portability, the cell phones have gradually become people's first camera, but the capacity of the cell phones themselves is limited. When the journey is limited by the capacity of the cell phones leading to can not shoot, inevitably spoil the fun. A camera aid is usually used for the cell phones to take pictures, while traditional camera aids only play a role in physical extending the photo distance and can not produce other functions for the cell phones. For example, the cell phones space due to photography and video and lead to too much storage space is occupied, as well as the cell phones tend to get hot when taking pictures, which seriously affect the user's experience.

### SUMMARY

In view of shortcomings and deficiencies in existing technologies, the present disclosure aims to provide a foldable camera aid that is capable of storing and reading data information of mobile devices and has advantage of reducing the temperature of the mobile device when shooting.

To achieve above objectives, the present disclosure adopts the following technical solutions. In some embodiments of the present disclosure, a foldable camera aid is provided, including a camera aid body. Herein the camera aid body includes a grip and a bracket, the bracket is rotationally assembled with the grip, one side of the bracket away from the grip is provided with a fitting part for assembly of a mobile device, and the fitting part is provided with a heat dissipation structure. The camera aid body is provided with a control circuit board coupled with a signal transmission unit, and the signal transmission unit is signal connected to the mobile device. The camera aid body is further provided with a storage module coupled to the control circuit board, and the storage module is configured to, via the signal transmission unit, store data information of the mobile device or send the data information to the mobile device.

Preferably, the fitting part is further provided with a fill light electrically connected to the control circuit board.

Preferably, the heat dissipation structure is a semiconductor radiator, and the semiconductor radiator is electrically connected to the control circuit board.

Preferably, the camera aid body is provided with a button section, the button section is coupled with the control circuit board, and the button section is configured to control switching of the fill light, switching of the semiconductor radiator, and shooting start and stop of the mobile device.

Preferably, a rotating shaft is provided between the grip and the bracket for them to rotate with each other.

Preferably, the fitting part is a housing and the semiconductor radiator is provided in the housing, one side of the housing is provided with a magnetic suction portion for adsorption to the mobile device, and another side of the housing is provided with the fill light.

Preferably, the signal transmission unit is a second interface, and the second interface is coupled to the mobile device via a data cable.

Preferably, the camera aid body is further provided with a power supply unit inside, and the power supply unit is coupled to the control circuit board.

Preferably, the camera aid body is further provided with a first interface electrically connected to the control circuit board, the power supply unit is a rechargeable battery, and the first interface is for charging the rechargeable battery by an external power source.

Preferably, the storage module is a hard disk, and the control circuit board is provided with a hard disk interface for insertion of the hard disk.

With the adoption of the above technical solutions, the foldable camera aid of the present disclosure has the following beneficial effects. By setting the bracket and grip on the camera aid body, with setting the fitting part on the bracket for assembly of the mobile device, and the heat dissipation structure is provided on the fitting part, which can dissipate heat for the mobile device on the fitting part. The camera aid body is provided with the control circuit board coupled with the signal transmission unit, and the signal transmission unit is signal connected to the mobile device. Moreover, the camera aid body is further provided with the storage module coupled to the control circuit board, and the storage module is configured to, via the signal transmission unit, store data information of the mobile device or send the data information to the mobile device.

### BRIEF DESCRIPTION OF THE DRAWINGS

In order to more clearly illustrate the technical solutions in the embodiments of the present disclosure or the prior art, the following will briefly introduce the accompanying drawings that need to be used in the description of the embodiments or the prior art, and it is obvious that the accompanying drawings in the following description are only some of the embodiments of the present disclosure, and that, for one person of ordinary skill in the art, other drawings may be obtained according to these drawings without paying creative labor.

FIG. 1 shows a structural schematic diagram of a foldable camera aid in accordance with some embodiments of the present disclosure.

FIG. 2 shows a schematic diagram of the foldable camera aid in a folded state corresponding to FIG. 1.

FIG. 3 shows a schematic diagram of the foldable camera aid that a rear cover being dismounted corresponding to FIG. 1.

In the drawings, reference signs are as follows. 1. Grip, 11. First interface, 12. Battery indicator hole, 13. Second interface, 14. Button section, 141. Cooling button, 142. Fill light button, 143. Shutter button, 15. Tripod nut, 16. Rear cover, 161. Heat dissipation hole, 17. Hard disk interface, 171. Hard disk, 18. Fan, 19. Headphone jack, 2. Rotating shaft, 3. Bracket, 4. Fitting part, 41. Heat dissipation structure, 42. Magnetic suction portion, 43. Fill light.

### DETAILED DESCRIPTION OF THE EMBODIMENTS

The present disclosure will be described in further detail below in conjunction with the accompanying drawings.

The specific embodiments are only explanations of the present disclosure, which is not a limitation of the present disclosure, one of ordinary skill in the art after reading this specification can make modifications to the embodiments as needed without creative contribution, which shall fall within the scope of protection of the appended claims of the present disclosure.

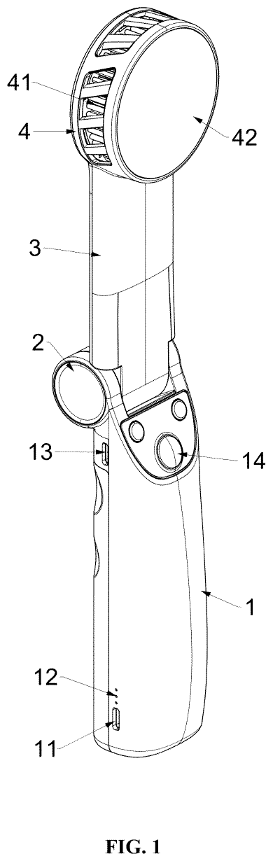

In some embodiments of the present disclosure, as shown in FIG. 1, a foldable camera aid is provided, including a camera aid body. The camera aid body includes a grip 1 and a bracket 3, the grip 1 is used for a user to hold to support the whole camera aid body and a mobile device assembled on the camera aid body. One side of the bracket 3 away from the grip 1 is provided with a fitting part 4 for assembly of the mobile device. In the embodiments of the present disclosure, the mobile device is an electronic product such as a cell phone, a pad, or a handheld game console.

Preferably, a control circuit board is provided in the camera aid body, and the control circuit board may be provided in the grip 1 or in the bracket 3. In the embodiments of the present disclosure, the control circuit board is provided in the grip 1, and a signal transmission unit is coupled to the control circuit board. The signal transmission unit can be used for signal transmission between the control circuit board and the mobile device, for example, the control circuit board can send control information to the mobile device, and the control information may be: control the mobile device to take pictures, or control the start and stop of the mobile device's video recording, and control other operations.

Moreover, a storage module is provided in the camera aid body, and the storage module is coupled to the control circuit board. The storage module may send the data information to the control circuit board, and then the control circuit board sends the data information to the mobile device via the signal transmission unit, this is possible to read the data information of the storage module for the mobile device. Similarly, the mobile device can send the data information to the control circuit board via the signal transmission unit, and the control circuit board sends the data information to the storage module, so that the storage module stores the data information. Specifically, photos or videos of the mobile device can be saved in the storage module through the transmission method described above, and similarly, the mobile device can read the photos or videos.

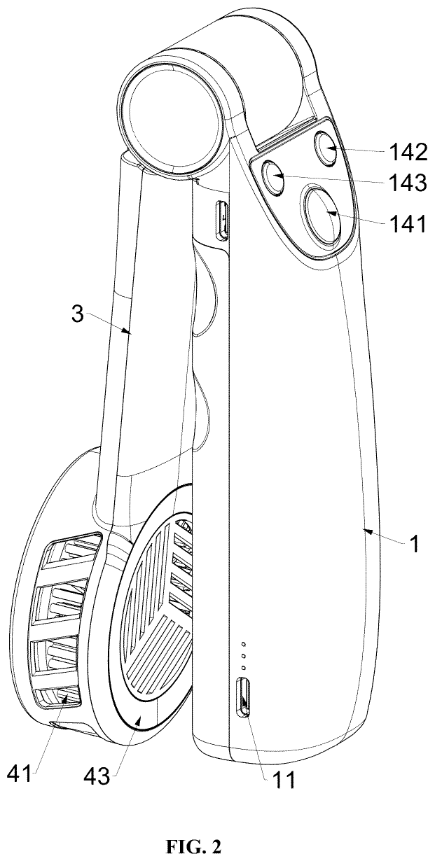

Referring to FIG. 2, a fill light 43 is provided on the fitting part 4, and the fill light 43 can emit light in a darker environment to improve the brightness of the mobile device when shooting. The fill light 43 is electrically connected to the control circuit board. Specifically, the fill light 43 is provided in a ring shape, and the light emitted therefrom is white or yellow, and the orientation of its light emitting surface is the same as the orientation of the camera of the mobile device.

Preferably, a heat dissipation structure 41 is provided on the fitting part 4, and the heat dissipation structure 41 can reduce the heat generated by the mobile device during use. Specifically, the heat dissipation structure 41 is a semiconductor radiator 18, which is electrically connected to the control circuit board and close to the mobile device, and generates a low temperature so as to reduce the temperature of the mobile device.

In some other embodiments of the present disclosure, the heat dissipation structure 41 is heat dissipation fins, and the heat dissipation fins transfers the heat emitted by the mobile device to the heat dissipation fins, thereby reducing the temperature of the mobile device. Alternatively, the heat dissipation structure 41 is a cooling fan, the cooling fan is electrically connected to the control circuit board, and the cooling fan plays a role of reducing the temperature of the mobile device by accelerating the air flow near the mobile device.

Preferably, the camera aid body is provided with a button section 14. Specifically, the button section 14 is provided on one side of the grip 1 near the bracket 3, which is convenient for the user to press the buttons on the button section 14 directly with the thumb when holding the camera aid. The button section 14 is provided with a plurality of buttons, and the buttons on the button section 14 are coupled with the control circuit board. The buttons on the button section 14 are as follows: a cooling button 141, a fill light button 142 and a shutter button 143. The fill light button 142 is used to control the switching of the fill light 43, the cooling button 141 is used to turn on or off the semiconductor radiator 18, and the shutter button 143 is used to control the shooting start and stop of the mobile device.

In some other embodiments of the present disclosure, the button section 14 is not provided with a button, and the button section 14 is a touch screen, which is for the user to touch the screen to realize control.

It is to be added that, the fitting part 4 is specifically a housing, which is provided in a cylindrical shape, with a semiconductor radiator 18 is set inside. The housing is provided with a plurality of holes, and the holes can be used as air inlet and outlet of the semiconductor radiator 18. A magnetic suction portion 42 is provided on one side of the housing, the magnetic suction portion 42 is used to adsorb the magnetic suction area of the mobile device so as to assemble the mobile device to the foldable camera aid of the present disclosure, and the fill light 43 is provided on the other side of the housing.

It is also to be added that, the bracket 3 is a hollow structure, the fill light 43 and the semiconductor radiator 18 both use wires to pass through the hollow structure of the bracket 3, and the wires are subsequently electrically connected to the control circuit board within the grip 1. In some other embodiments, a PCB board is provided in the hollow structure of the bracket 3, and the fill light 43 and the semiconductor radiator 18 are coupled with the PCB board through the wires. The PCB board is coupled with the control circuit board in the grip 1, which also enables the control circuit board to control the fill light 43 and the semiconductor radiator 18. In the embodiments, the bracket 3 is rotationally assembled with the grip 1, both of which are rotationally assembled by means of a rotating shaft 2, so that the bracket 3 and the grip 1 can rotate with each other.

Preferably, the signal transmission unit is a second interface 13, and the second interface 13 is coupled with the mobile device by plugging in the data cable, so as to realize the signal data transmission between the control circuit board and the mobile device. A power supply unit is further provided in the camera aid body, the power supply unit is electrically connected to the control circuit board, and the power supply unit can supply power to the electronic components of the entire camera aid through the control circuit board.

It is also to be added that, the camera aid body is further provided with a first interface 11 electrically connected to the control circuit board. The power supply unit is a rechargeable battery, and the first interface 11 is provided for charging the rechargeable battery by an external power source. Similarly, the first interface 11 can also charge the mobile device directly from the external power source via the second interface 13, thereby providing a longer endurance for the mobile device. In the embodiments, the first interface 11 and the second interface 13 are usb-c interfaces. In some other embodiments, the first interface 11 and the second interface 13 are usb-a interfaces or lightning interfaces.

Preferably, the first interface 11 and the second interface 13 are both provided on the same side of the grip 1, the second interface 13 is provided close to the mobile device, and the first interface 11 is provided away from the mobile device. The other side of the grip is provided with a headphone jack 19 electrically connected to the control circuit board, the headphone jack 19 is connected to the mobile device through the first interface 11, when the headphone jack 19 is plugged into an external audio device, it will replace the microphone that comes with the cell phone.

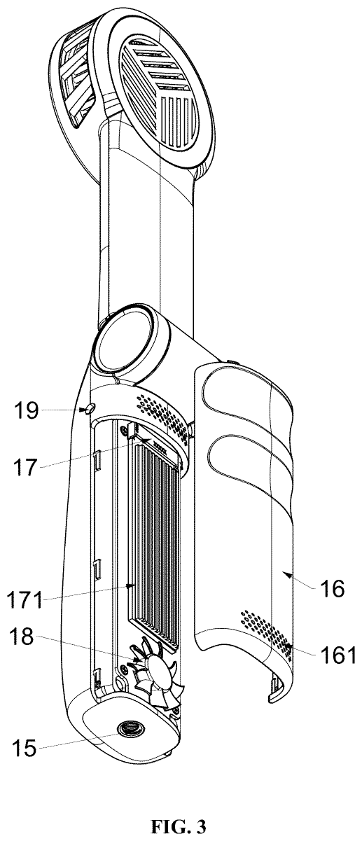

Referring to FIG. 3, one side of the grip 1 that far away from the button section 14 is provided with a rear cover 16, the rear cover 16 is assembled with the grip 1 in a sliding type, and the internal structure of the grip 1 may be exposed by sliding the rear cover 16. The storage module is a hard disk interface 17, and the hard disk interface 17 is set inside the grip 1. The hard disk interface 17 is coupled with the control circuit board, and the hard disk interface 17 may be used for the insertion of the hard disk 171. In some other embodiments, the storage module is an SD card slot, which is electrically connected to the control circuit board, and can be used by inserting an SD card into the SD card slot. The SD card slot may be provided in the grip 1 near one side of the rear cover 16, so as to protect the SD card and the SD card slot when the rear cover is closed, it also may be exposed on the surface of the grip 1 for easy insertion and removal of the SD card.

In the embodiments of the present disclosure, a fan 18 is provided inside the grip 1, and the fan 18 may be used to reduce the temperature generated when the electronic components inside the grip 1 are working. Heat dissipation holes 161 are also provided on the grip 1 and the rear cover 16, and the heat dissipation holes 161 can be used as air inlet holes and air outlet holes of the fan 18.

Preferably, a tripod nut 15 is provided at the bottom of the grip 1, that is, one end of the grip 1 away from the bracket 3. The tripod nut can be fitted with a tripod to realize the stable placement of the camera aid and avoid the shaking generated by handholding the camera aid, so as to improve the user's shooting experience.

The forgoing is only used to illustrate the technical solutions of the present disclosure and not a limitation, and other modifications or equivalent replacements made to the technical solutions of the present disclosure by one of ordinary skill in the art, as long as they do not depart from the concept and scope of the technical solutions of the present disclosure, should be covered by the scope of protection of the appended claims of the present invention.

What is claimed is:

1. A foldable camera aid, comprising a camera aid body;
wherein the camera aid body comprises a grip and a bracket, the bracket is rotationally assembled with the grip, one side of the bracket away from the grip is provided with a fitting part for assembly of a mobile device, and the fitting part is provided with a heat dissipation structure;
wherein the camera aid body is provided with a control circuit board coupled with a signal transmission unit, and the signal transmission unit is signal connected to the mobile device; and
wherein the camera aid body is further provided with a storage module coupled to the control circuit board, and the storage module is configured to, via the signal transmission unit, store data information of the mobile device or send the data information to the mobile device.

2. The foldable camera aid according to claim 1, wherein the fitting part is further provided with a fill light electrically connected to the control circuit board.

3. The foldable camera aid according to claim 2, wherein the heat dissipation structure is a semiconductor radiator and the semiconductor radiator is electrically connected to the control circuit board.

4. The foldable camera aid according to claim 3, wherein the camera aid body is provided with a button section, the button section is coupled with the control circuit board, and the button section is configured to control switching of the fill light, switching of the semiconductor radiator, and shooting start and stop of the mobile device.

5. The foldable camera aid according to claim 1, wherein a rotating shaft is provided between the grip and the bracket for them to rotate with each other.

6. The foldable camera aid according to claim 3, wherein the fitting part is a housing and the semiconductor radiator is provided in the housing, one side of the housing is provided with a magnetic suction portion for adsorption to the mobile device, and another side of the housing is provided with the fill light.

7. The foldable camera aid according to claim 1, wherein the signal transmission unit is a second interface and the second interface is coupled to the mobile device via a data cable.

8. The foldable camera aid according to claim 7, wherein the camera aid body is further provided with a power supply unit inside, and the power supply unit is coupled to the control circuit board.

9. The foldable camera aid according to claim 8, wherein the camera aid body is further provided with a first interface electrically connected to the control circuit board, the power supply unit is a rechargeable battery, and the first interface is for charging the rechargeable battery by an external power source.

10. The foldable camera aid according to claim 1, wherein the storage module is a hard disk, and the control circuit board is provided with a hard disk interface for insertion of the hard disk.
